(19) United States
(12) Patent Application Publication
(10) Pub. No.: US 2021/0056603 A1
(43) Pub. Date: Feb. 25, 2021

(54) System, Device, and Method of Collaborative Gaming

(71) Applicant: Joel Vidal, Jupiter, FL (US)

(72) Inventor: Joel Vidal, Jupiter, FL (US)

(21) Appl. No.: 16/550,198

(22) Filed: Aug. 24, 2019

(51) Int. Cl. G06Q 30/06; A63F 13/86; G06Q 30/08; A63F 13/355

(52) U.S. Cl. CPC G06Q 30/0611; A63F 13/355; G06Q 30/08; A63F 13/86

(57) ABSTRACT

System, device, and method of collaborative gaming. A first user plays a game on his electronic device, and gets stuck at a particular level or obstacle. The first user requests other users to assist him to pass that level or obstacle. An assisting user utilizes his own, separate, electronic device, for the specific purpose of temporarily engaging with that same game, at the same level or obstacle for which the assistance was requested by the first user. Success of the assisting user to pass that level or obstacle, on his own electronic device, causes the game-play on the electronic device of the first user to advance to the next level in that game, as if it was the first user who succeeded in passing. Optionally, a bidding mechanism, or an auction or a reverse auction, are used to allocate game assistance requests to candidate assisting users.

### FIELD

The present invention relates to the field of gaming, and particularly to electronic games, video games, and online games.

### BACKGROUND

Electronic devices and computing devices are utilized on a daily basis by millions of users worldwide. For example, laptop computers, desktop computers, smartphone, tablets, and other electronic devices are utilized for browsing the Internet, consuming digital content, streaming audio and video, sending and receiving electronic mail (email) messages, Instant Messaging (IM), video conferences, playing games, or the like.

### SUMMARY

Some embodiments of the present invention may provide systems, devices, and methods of collaborative gaming. For example, a first user plays a game on his electronic device, and gets stuck at a particular level or obstacle. The first user requests other users to assist him to pass that level or obstacle. An assisting user utilizes his own, separate, electronic device, for the specific purpose of temporarily engaging with that same game, at the same level or obstacle for which the assistance was requested by the first user. Success of the assisting user to pass that level or obstacle, on his own electronic device, causes the game-play on the electronic device of the first user to advance to the next level in that game, as if it was the first user who succeeded in passing. Optionally, a bidding mechanism, or an auction or a reverse auction, are used to allocate game assistance requests to candidate assisting users.

For example, a first user utilizes a first electronic device (e.g., smartphone, tablet, desktop computer, laptop computer, gaming console, gaming device) to interact with a particular game. During his gameplay, the first user gets stuck in a particular level, or is unable to pass a particular in-game obstacle or in-game enemy, or is unable to reach or meet an in-game requirement (e.g., a requirement to pass a particular level or obstacle within a pre-defined time-period; a requirement to collect a minimum amount of in-game coins or objects within a particular game-portion or time-period). The first user may initiate a request for assistance; or, the first electronic device, or a remote server, may detect that the first user is stuck and may propose to initiate the request for assistance. The request is sent to a second user, which operates a second, different, electronic device; requesting the second user to utilize his second electronic device for the specific and limited purpose of interacting with that particular game, at exactly the particular level or game-portion in which the first user requests (and needs) assistance. Optionally, the first user selects who the second user (the assisting user) would be, from a list of contacts or friends of the first user, or from a pool or list of other users that the first user may not necessarily know and that had indicated to the gaming system that they are willing and/or able to assist other users in passing an in-game level or obstacle. Optionally, the first user may assign or propose a payment amount that he is willing to pay to the second user (a particular second user, or to any second user that the system would select and engage) in exchange for the services of the second user passing that in-game level or obstacle for (or, on behalf of), and/or for actually positive result or successful result of passing the level or enemy or obstacle on behalf of the first user, and/or for merely attempting to do so (even without necessarily succeeding). Optionally, a bidding or auction or reverse-auction mechanism may be conducted automatically and/or electronically, such that the gaming system or the remote server would allocate the task of attempting to pass the level (or enemy, or obstacle) to a particular second user that was the first to accept the request, or that was the first in a line or queue of pre-registered users and/or pre-defined users, and/or that was offering or bidding the lowest amount of compensation in exchange for is service. Once selected, the second user utilizes his own (second) electronic device, to engage with the same game, at exactly the particular level or game-portion for which the first user requested assistance. If the second user is successful in passing, in general or within a pre-defined time-period (e.g., 30 minutes; which may optionally be pre-defined by the requesting user (the first user) and/or by the gaming system) or within a pre-defined number of attempts (e.g., within 3 attempts or by using up to three in-game “lives”; which may optionally be pre-defined by the requesting user (the first user) and/or by the gaming system), then, the electronic device of the second user indicates such success to the remote server or the gaming system, which in turn notifies accordingly the first electronic device (and the first user, who is the requesting user); and the game in the first electronic device is updated or modified or configured to reflect as if that level (or enemy, or obstacle) was passed or was traversed by the first user on the first electronic device, and to enable and/or authorize the first user to continue playing the game from the next level of that game. Optionally, the first user may be authorized to continue attempting to pass the level while the second user attempts in parallel; or, in other embodiments, a first user that requested assistance, is temporarily prevented from attempting to pass that level (since other user(s) are now trying to do so on is behalf, optionally in exchange for a monetary compensation). In some embodiments, optionally, the gaming system may allocate to a group or subset of multiple users (e.g., to five users) the task of attempting to pass the level at which the first user requested assistance; and the user, out of those five assisting users, who is the first one that succeeds in the assistive task, receives the monetary compensation. In some embodiments, optionally, the monetary compensation is collected from a payment method or a payment means of the first user (e.g., bank account; credit card; debit card; crypto-currency; pre-paid online credit; or the like), and is transferred to the game administrator; optionally, the collected money or the collected compensation, is divided between the game administrator (or game operator) and the second user who succeeded in traversing or passing the level on behalf of the first user; and optionally, also with one or more other users that attempted but did not succeed (or, that succeeded but were not the first to succeed) in passing that level (or enemy, or obstacle) on behalf of the first user.

The present invention may provide other and/or additional advantages and/or benefits.

### BRIEF DESCRIPTION OF THE DRAWINGS

FIG. 1 is a schematic illustration of a system, in accordance with some demonstrative embodiments of the present invention.

### DETAILED DESCRIPTION OF SOME DEMONSTRATIVE EMBODIMENTS

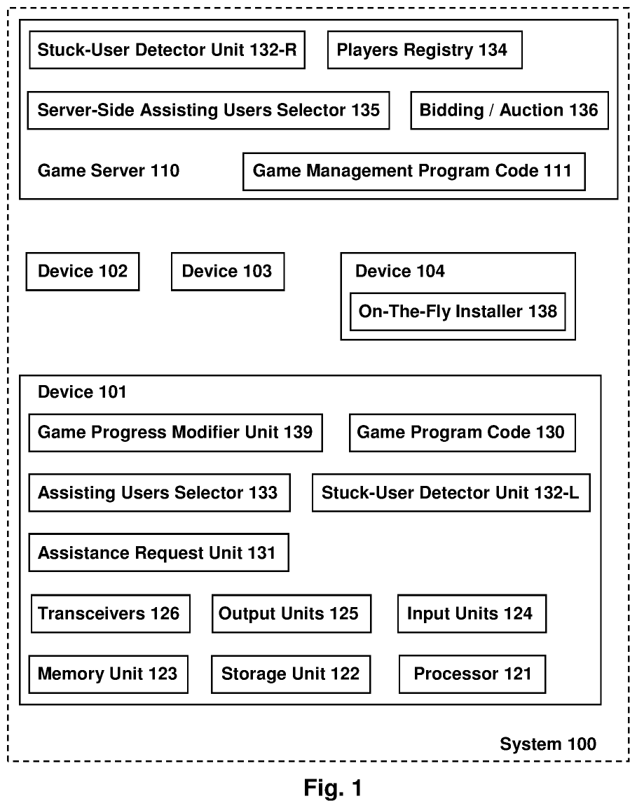

Reference is made to FIG. 1, which is a schematic illustration of a system, in accordance with some demonstrative embodiments of the present invention. System 100 may comprise a first electronic device 101, operated by a first user (who may also be referred to herein as “the requesting user” or “the assisted user” or “the stuck user” or “the original user” or “the primary user”). System 100 may further comprise one or more other electronic devices; for example, there are shown electronic devices 102-104.

Each one of electronic devices 101-104 may be or may comprise, for example, a smartphone, a tablet, a portable gaming device, a non-portable gaming device or gaming console, a television-connected or monitor-connected gaming device, a laptop computer, a desktop computer, or the like.

In some embodiments, electronic devices 101-104 are not co-located; and are located away or remotely from each other; and their respective owners or users do not necessarily know each other. In other embodiments, two or more of the devices 101-104 may optionally be co-located (e.g., in the same house or venue; in the same organization; in the same classroom or school; or the like), and their owners or users may know each other (e.g., being friends, colleagues, co-workers). In still other embodiments, two or more of the devices 101-104 may optionally be located in the same venue, yet their owners or users may not necessarily know each other and/or be aware of the existence or location of other device(s) (e.g., two students in the same school; two employees in the same large organizational venue). The user(s) of such other devices 102-104, may optionally be referred to herein as “the assisting users” or “the helping users” or “the secondary users”).

The first user utilizes or operates his device 101 to engage or interact with a particular game. The game may be, for example, a video game, an electronic game, an online game, a game in a browser, a mobile-friendly game, a gaming console game, a stand-alone along game, a game that requires partial or full local installation on device 101 in order to operate fully or partially, a game that does not require installation on device 101 and is accessible via the Internet and/or via a web browser, or other suitable type of game.

The game may be a one-player game or a single-player game, in which a single player interacts and engages with the game and needs to accomplish in-game tasks; for example, to shoot and hit virtual or in-game or on-screen enemies or monsters or creatures, to collect virtual/in-game/on-screen coins or objects or items or “power-ups”, to control and move an on-screen avatar or character (e.g., to move it sideways, up and down; to make it jump or crawl or shoot; or the like), and/or to perform other in-game operations. Alternatively, the game may be a multi-player or multiple-player game, in which two or more players (which may be humans, and/or may be computer-based or machine-based, or may be emulated by a computing device) play together and/or play against each other and/or play against a common opponent or enemy.

The game operations may be provided by the user via one or more input units and/or game controllers and/or input methods; for example, keyboard, keypad, mouse, track-ball, touch-pad, touch-screen, joystick, Virtual Reality (VR) or Augmented Reality (AR) glasses or gear or headset or headgear, portable or wearable game controllers or input units, motion-based or gesture-based input units in which one or more sensors and/or cameras sense or detect motion or movement or other gestures of the user, microphone enabling to provide audio input, or the like.

Optionally, system 100 may comprise a game server 110, able to manage, control and/or provide one or more of the functionalities of the game, and/or one or more features related to the game (e.g., score-board, leaderboard, player rankings; player management services, such as creation of username and password, registration process, log-in process, or the like), and/or able to communicate over wired and/or wireless communication link(s) and/or network(s) and/or the Internet with one or more of the devices 101-104. In some embodiments, for example, game server 110 may enable a user to download the program or application or “app” of the game into his device and/or to otherwise facilitate the installation and/or the execution of the game. In some embodiments, game server 110 may serve one or more data-items or content to the device(s) that engage with the game or play it, may serve program code that when executed on the end-user device cause the end-user device to run the game, may receive from them data (e.g., current score, current progress), may send to them data (e.g., progress and scores and status of other players), or the like. In some embodiments, game server 110 may provide to devices 101-104, or to some of them, the ability to communicate with each other, to send text messages and/or audio messages and/or video messages to each others, the ability to capture and/or share with other devices a current status of the game on a particular device, or the like. In some embodiments, game server 110 may enable one or more devices 102-104, or other third parties, to view and/or to replay a playback of a game or a game-portion that was played on device 101, in real time, or in near-real-time (e.g., within 1 or 2 seconds of actual live play), and/or in retrospect or subsequently (e.g., enabling device 102 to playback on Tuesday, a gameplay that was played on device 101 on Monday). These functionalities may be provided by game server 110 via a processor that executes program code stored in a memory unit or storage unit of game server 110, for example, a Game Management Program Code 111. In some embodiments, optionally, one or more of the functionalities of the game server 110 and/or the Game Management Program Code 111 may be implemented as part of one or more of the devices 101-104, which may perform such management operations; particularly when a peer-to-peer architecture is utilizes rather than a central gaming serer with multiple end-user devices architecture; or, such functionalities, or some of them, may be implemented as part of one or more of devices 101-104 in addition to game server 110 providing other functionalities and/or the same functionalities, for example, in order to reduce or divide or split the work-load and/or the communication bandwidth and/or processing resources utilized by game server 110, and/or in order to speed-up the communication among two or more of the devices (e.g., device 101 may directly communicate with device 102, both of them located in the same school in California; without necessarily being required to communicate via the remote game server 110 which may be located in France).

The game is executed by, or on, device 101 by executing instructions of game code. For example, device 101 may comprise a processor 121 able to execute program code 130 (e.g., a central processing unit (CPU), a digital signal processor (DSP), a graphics processing unit (GPU), one or more processing cores, or the like); a storage unit 122 able to store the program code as well as data and content utilized in the game (e.g., video clips, animations, graphics, text, audio, sound effects, audio soundtrack, or the like), such as a hard disk drive (HDD), a solid state drive (SDD), an optical disk drive (e.g., DVD or CD); a memory unit 123 able to temporarily store data and/or code (e.g., Flash memory; random access memory (RAM); or the like); one or more input units 124 (e.g., as listed above); one or more output units 125 (e.g., screen, touch-screen, audio speakers, audio out socket, earphones, or the like); an operating system (OS) with accompanying drivers and programs; one or more wired transceivers and/or modems and/or wireless communication transceivers, such as a Wi-Fi transceiver, a cellular transceiver (e.g., 2G or 3G or 4G or 4G-LTE or 5G cellular transceiver(s), a Bluetooth transceiver, and/or other transceivers 126; a power source (e.g., battery, rechargeable battery, power cell, connection to mains electricity outlet), and/or other hardware components and/or software components. Device 102, device 103, device 104, and/or game server 110, may comprise similar components to those of device 101; they are not shown explicitly in the drawing of FIG. 1 in order to avoid over-crowding of the drawing.

The game that is played by the first player via his device 101 may include multiple game-portions or Levels. A game-portion may be, for example, a level in a game, an area in a game, or other zone or portion of the game, in which the user is required to successfully perform certain operations in order to continue to the next level (e.g., shoot and hit a certain number of enemies or targets; collect a certain number of coins or items; traverse or navigate around a particular map-portion or route; successfully cross certain in-game obstacles; or the like; and such that if the user fails to perform the required operations in that level (game-portion), or fails to perform them within a pre-defined time-limit or other constraint, then the game-play returns to the beginning of that level or to another milestone within that level, and the player is not authorized to proceed to the next level unless and until he successfully completes this level. In some embodiments, the first user may be required, after a certain number of attempts are exhausted, such as, after his in-game character “dies” three times (e.g., exhausting is three in-game “lives”), to restart the entire game from its first level (Level 1); whereas, in other games, failure of the first user to successfully traverse or pass a level may cause the game-play to return repeatedly to the beginning of that failed level, or to another milestone (e.g., half-way through) within that failed level.

In accordance with some embodiments of the present invention, the first player gets “stuck” in a certain level of the game, such as in Level 17 of a platform game or a shooting game that comprises a total of 30 Levels. For example, the first player repeatedly tries to pass or to complete Level 17, but repeatedly fails; such as, for ten attempts in a row, or for ten attempts within one hour or within one day, or for multiple attempts within a time-period (e.g., a week), or the like.

For example, during his gameplay via device 101, the first user gets stuck in a particular level (e.g., Level 17), or is unable to pass a particular in-game obstacle or in-game enemy, or is unable to reach or meet an in-game requirement (e.g., a requirement to pass a particular level or obstacle within a pre-defined time-period; a requirement to collect a minimum amount of in-game coins or objects within a particular game-portion or time-period).

In some embodiments, the first user may utilize his device 101 to initiate a request for assistance. For example, game program code 130 that is installed on device 101 or that runs on device 101 (e.g., as an in-browser code, such as, JavaScript and HTML5 and CSS components), may include a program code portion that implements an Assistance Request Unit 131. For example, the game program code 130 and/or the Assistance Request Unit 131 generate an on-screen element (e.g., User Interface (UI) element, or Graphical UI (GUI) element, such as an on-screen button, link, hyperlink, or other UI/GUI element) that, once engaged by the first user, causes the device 101 and/or the game program code 130 to generate an Assistance Request, or a message or notification that indicates that the first player who utilizes device 101 is stuck at a particular Level (e.g., Level 17) of a particular Game, or otherwise indicating a particular milestone or game-portion or game-milestone within the game (e.g., the Third obstacle in Level 17; or, the “Boss” enemy in Level 17).

Additionally or alternatively, system 100 may comprise a Stuck-User Detector Unit, able to autonomously and/or automatically detect or estimate that the first user is stuck at a particular point or milestone or level or game-portion of the game. For example, a locally-implemented Stuck-User Detector Unit 132-L may be implemented locally within device 101, such as being a part of the game program code 130; and may track or monitor the progress of the gameplay, and may apply one or more detection rules in order to detect the stuck situation. Additionally or alternatively, a remotely-implemented Stuck-User Detector Unit 132-R may be implemented remotely, on game server 110, as part of the Game Management Program Code 111 that runs on the game server 110, and may receive continuous and/or periodical updates from device 101 about the progress of the gameplay (e.g., every second, or every N seconds, or every minute, or upon the termination of a game due to exhaustion of “lives”, or the like), and may monitor the progress and apply similar detection rules. For example, the detection rules that are applied locally and/or remotely, may check whether the user of device 101 has repeatedly started the game for at least N times at the same particular level; or, whether the user of device 101 has ended the game (e.g., his in-game avatar has “died”) repeatedly at the same particular level for at least N times; or, whether the user of device 101 has played at least M minutes in a particular Level or game-portion of the game (e.g., consecutively; or in some embodiments, non-consecutively and in the aggregate); or, whether the user of device 101 has failed at least N times to traverse a particular in-game obstacle (or, to reach a particular in-game goal), wherein N is counted for that user in the aggregate, or wherein N is counted for the user within a pre-defined time period (e.g., within a single day, or a single week); and/or whether other pre-defined conditions are met, indicating that the user of device 101 is stuck at a particular Level or game-portion of the game. Upon such automatic detection, the Stuck-User Detector Unit (132-L and/or 132-R) may trigger an Assistance Proposal Generator unit or module, which may be part of the Stuck-User Detector Unit or may be associated therewith, to generate and to provide to the user of device 101, a notification that the gaming system estimates that the user is stuck and that the gaming system suggests that the user would proceed with an Assistance Request.

Accordingly, either based on his own volition and desire of the user of device 101, or based on an automated detection and proposal from the gaming system, the user of device 101 may initiate an Assistance Request. For example, he may engage an on-screen GUI element to indicate that he is requesting assistance to pass the particular level or obstacle or game-portion at which he is currently located (e.g., during his actual live gameplay; or, after the user of device 101 has performed a Pause operation to pause the gameplay; or, after the user of device 101 has ended the gameplay, such as, after his on-screen avatar has “died” and ended the gameplay at Level 17 of the game). The assistance request indicates, for example: an identifier of the game that is played by the user of device 101 (e.g., “Mario Bros”); an identification of one or more game properties (e.g., “Version 3.1.2” or “Build 2017.08.23”); an identification of one or more properties of device 101 (e.g., “iPhone X”, or “Windows 10 Professional”, or “Firefox 64.0.1”); an indication of one or more properties of the user of device 101 (e.g., “username=JohnSmith”, or “User-ID=43216789”, or “user-account=John@Gmail.com”); an indication of the particular game-level or game-area or game-portion for which the assistance request is directed (e.g., “Level 17”, or “Area 17”, or “Stage 17”), and optionally, a more high-resolution or higher-granularity milestone of the particular obstacle or game-portion for which the assistance is requested (e.g., “Boss enemy in Level 17”, or “Third Monster from the start of Level 17”, or “Alien Spaceship in Level 17”); indication of the exact current status or progress of the game on device 101 (e.g., “the requesting user has the Ultra spaceship”, or “the requesting user has obtained the Wings power-up”, or “the requesting user has not yet obtained the Speed Booster power-up”); a time-and-date stamp of the generation or the sending of the assistance request (e.g., to ensure that only “fresh” requests are handled), and optionally a time-to-live (TTL) parameter associated with the request or an expiration time-and-date for the assistance request (e.g., “TTL=120 minutes”, or “Expiration=2017-08-23 at 15:59 GMT”); optionally, an indication of one or more compensation items that the requesting user is offering, or is willing to pay or provide, in exchange for another user's successful passing of the level or obstacle on his behalf, and/or in exchange for the mere attempt by one or more particular users to do so (e.g., “Compensation=USD 2 for success only”, and/or “Compensation=0.003 Bitcoin to be split among all users that attempt on my behalf within 30 minutes from now”); an indication whether the assistance request is revocable by the requesting user, or is non-revocable; and/or other suitable data-items or parameters.

Optionally, an Assisting Users Selector Unit 133 enables the requesting user to utilize his device 101 in order to select one or more particular user(s), of device(s) 102-104, to which the assistance request would be sent. For example, the requesting user may select one or more particular recipients from the Contacts application or Contacts list on is device 101; or, from another list of Contacts that are associated with the requesting user (e.g., associated with his email address or email account; or his “friends” or “connected” or “following” or “followed” users on a social networking website or system). Additionally or alternatively, the requesting user may request from the remote game server 110 to select such other recipients, randomly or pseudo-randomly from a registry of users who have the same game installed and/or currently running and/or currently being played; and/or the requesting user may define one or more selection criteria that the game server 110 and/or is own device 101 would apply or enforce for the selection process (e.g., “select only users that have already passed Level 25 to assist my request to pass Level 17”; or, “select only users that have played this game on their device for at least 60 days”; or “select only users that have played this game on their device for at least 7 hours in the aggregate”; or, “select only users that have at least 580 XP points or Experience Point, or that reached a high score of at least 18,000 points”; or the like).

Game server 110 may store a Players Registry 134, with records and identifiers about each device and/or user that downloaded and/or installed and/or played and/or currently plays the same game, and optionally also storing the current status and/or historical status of such other devices or users. For example, Players Registry 134 may store a record that indicates that device 102 has reached Level 24 in the game; or a record that indicates that the user “John@Gmail.com” is playing currently on Level 12 through device 103; or that the user having a User-ID number “1234567” had reached a high-score of 18,500 points on date 2018-09-23; or the like. Players Registry 134 may further indicate which player(s) are currently online and/or playing; such as, by “pinging” or sending a “ping” query to players, or by monitoring which users or devices currently send status updates or other commands or transmissions to the game server 110.

Players Registry 134 may further store one or more criteria or parameters that are associated with each user or each device; for example, storing an indication by the user of device 102 that she never wants to be contacted with assistance request of other persons; storing an indication by the user of device 103 that he wants to be contacted with assistance requests only on Saturdays and Sundays, and/or only between 4 to 7 PM GMT; storing an indication by the user of device 104 that he wants to be contacted with assistance requests that are coupled with a proposal to pay at least USD 1.50 for success and/or at least USD 0.50 for an attempt; storing an indication by the user of device 104 that he wants to be contacted with assistance request only if they are directed to Levels 12 to 17; and/or other criteria or conditions that the users of devices 102-104 may define, set and/or modify from time to time.

A Server-Side Assisting Users Selector 135 may apply such selection criteria or conditions, set by the requesting user and/or set by other users, in order to find suitable match(es) for candidate assisting users that may be able to fulfill the assistance request. Optionally, a first-in-first-out (FIFO) mechanism, or other rules, may also be applied to the selection process; such that, for example, out of N suitable candidates to act at the assisting user, the user that was the first one to install the game and/or to register as a candidate for assisting other users is allocated the assistance request at hand. In other embodiments, a quota may be pre-defined or enforced, such that, for example, a single assisting user may not be allocated more than N assistance requests per time-period (e.g., per day, per week). In other embodiments, other allocation rules may be applied, to ensure that assistance requests are allocated on a fair basis to “experienced” users who joined the game years ago or months ago, as well as to “fresh” users who joined the game only a few hours or days ago; such as, by alternating between such groups, and selecting in the alternate an experienced user for a first assistance request, then selecting a fresh or less-experienced user for the next assistance request, then again selecting another experienced user for the next assistance request, and so forth.

In some embodiments, a Bidding/Auction Unit 136 may be utilized by system 100, in order to allocate the assistance request. The Bidding/Auction Unit 136 is sown as part of game server 110; although it may be implemented, additionally or alternatively, as part of device 101. In a first example, the Bidding/Auction Unit 136 publishes to multiple users (e.g., the users of devices 102-104) the assistance request of device 101 that is coupled to a reward of USD 1.50 for successful completion of Level 17; and the user of device 102 or 103 or 104 who is the first to respond positively to the request is allocated the request for fulfillment; if he fails, the request is re-offered to the other users, or the request rolls-over automatically and is re-allocated to the second user to respond to the proposal. In a second example, once the assistance request is published, a reverse auction process is executed, in which each one of devices 102-104 may submit back his counter-offer within a pre-defined time period (e.g., 60 seconds), and the lowest bidder wins the reverse auction and is allocated the assistance request for fulfillment (e.g., device 102 counter-offered USD 1.30, and device 103 counter-offered USD 1.20, and thus device 103 wins and is allocated the assistance request for fulfillment); optionally, the time-period may be extended upon receipt of each new counter-offer. Other suitable bidding or auctioning or selection processes may be used.

In some embodiments, the game server 110 may collect a bidding fee from users (e.g., of device 102 or 103 or 104) that propose to act as assisting users, as a condition of their participation in an auction or reverse-auction or other bidding process.

In some embodiments, additionally or alternatively, the user of device 102, if he is selected to act as an assisting user, may be required to pay a pre-defined monetary amount that would be kept by the system administrator if that user (of device 102) fails to fulfill the Assistance Request of device 101. For example, the requesting user of device 101 proposes a reward of USD 2.50 to the first assisting user that would complete Level 17 on his behalf. The user of device 102 pays (or agrees to pay, or obligates to pay) USD 1.00 if he is allocated the task and fails it. If the user of device 102 fails to fulfill the Assistance Request within a pre-defined time-period that was allocated to it, then the payment of USD 1.00 is collected from the assisting user of device 102 (who failed), and is kept by the system administrator, who may optionally provide a portion of that payment to the requesting user of device 101; and the requesting user of device 101 may not be required to pay the promised reward of USD 2.50 since the assisting user has failed to fulfill. Alternatively, if the assisting user of device 102 has succeeded to fulfill the assistance request, then, the proposed reward of USD 2.50 is collected from the requesting user of device 101 and is transferred to the game administrator; who may provide full or partial payment of that reward to the successful assisting user (of device 102); and, the successful assisting user (of device 102) may not be required to pay his USD 1.00 participation fee, or such fee (if was already deposited by the user of device 102) may be returned to the user of device 102.

In some embodiments, optionally, the assistance request may be allocated in parallel to multiple devices (e.g., to five devices); and the first device to fulfill the assistance request (e.g., by successfully passing Level 17 on behalf of the requesting user) is awarded the prize or the compensation that was coupled to the assistance request.

Once the device (102 or 103 or 104) of an assisting user is allocated the assistance request, such device, which may be referred to herein as the Assisting Device (of the Assisting User), may modify its performance. In some embodiments, for example, at the time of the incoming allocation of the Assistance Request, the Assisting User is not currently playing with the game on device 102; but rather, device 102 is idle (not in use), or the Assisting User is engaged with a different application on device 102 (e.g., playing a different game; watching a streaming video; composing an email message); in such situation, upon receipt of the signal indicating an incoming assistance request, device 102 may generate and output a notification (e.g., a pop-up message, an audio message, an overlay window, a drop-down message that is viewable at the top portion of the screen, or the like) to indicate the incoming assistance request. The user of device 102 may reject the assistance request (e.g., tap on “I am busy now, request is rejected”); or may snooze or delay it (e.g., “I am busy now, will handle the assistance requests in three minutes”), or may immediately accept the assistance request (e.g., “I accept, please proceed”). Upon acceptance, device 102 may launch the same game to which the assistance request is directed; and may configure the game such that the gameplay would commence now, on device 102, at the same level (Level 17 in the above example) at which the Requesting User was stuck and for which the Assistance Request was generated; and such that the game-play would be conducted on device 102 according to the same properties that the Requesting User has on his device 101 (e.g., “Already obtained the Booster power-up”, and “Did not yet obtain the Rapid Shooter power-up”). The user of device 102, acting as the Assisting User, can now operate his device 102 to engage with the game at Level 17; optionally, for a pre-defined time-period that was attached or coupled to the assistance request, or that is generally pre-defined in the system 100 (e.g., for ten minutes). Device 102 is thus dynamically configured, on-the-fly, to temporarily authorize and enable its user (the assisting user) to interact with the game as if he (the assisting user) was the requesting user, from the same in-game level or in-game milestone that was most recently achieved or saved by the requesting user on his device 101, and for a limited time, and for the limited purpose of passing or traversing that particular obstacle or level on behalf of (of for, or instead of, or in lieu of) the requesting user; and while configuring or re-configuring or updating the game program code that runs on device 102 such that the game-play of that level on the assisting device 102 would be identical or very similar to the game-play of that level on the requesting device 101, for example, featuring on the assisting device 102 the same “power-ups” or “upgrades” (or other in-game features or in-game achievements) that were already obtained by the requesting user on his device 101 (e.g., even if they were not already achieved by the assisting user in his role as an original user playing for his own behalf on device 102), and/or featuring on the assisting device 102 a lack of in-game features or a lack of in-game achievements (e.g., “power-ups” or “upgrades”) that were not yet collected or achieved by the requesting user on his device 101 (e.g., even if the assisting user had already achieved or collected such in-game features in his role as an original user playing for his own behalf on device 102). The system of the present invention may thus duplicate or replicate or emulate or simulate or implement the game-play experience, as was most recently experienced by the requesting user on his device 101, in or into or onto the assisting device 102 operated by the assisting user for the purpose of passing the level or obstacle for which the assistance was requested.

If within the allocated time-limit, the user of device 102 succeeded in passing Level 17, then, device 102 transmits a Request Fulfilled message, indicating so to the game server 110 and/or directly to the request device 101; and based on such Request Fulfilled message, the game program code in device 101 (and/or the game management program code in server 110) are updated or modified or configured such that the game-play of the game on device 101 would reflect that Level 17 was passed and that the user of device 101 is allowed to proceed and play that game on device 101 at level 18 and onward. If the assisting user did not succeed in fulfilling the assistance request within the allocated time-slot, then his device 102 may transmit a message indicating such failure; and the failure may optionally be reported to the requesting user on device 101; and the original request may be re-allocated to another assisting user who operates another device (103 or 104), or to a group of multiple such users operating multiple such devices.

In another example, the assistance request is received at device 103, while its user is engaging with the same game at Level 8. Even though the user of device 103 is not yet authorized, by the game program code that runs on device 103, to access Level 17, the game program code is configured or modified in view of the incoming Assistance Request to temporarily authorize such time-limited access of the user of device 103 to Level 17, such as for ten minutes only, for the specific purpose of acting as an Assisting User relative to the incoming Assistance Request. Upon successful completion of the Assistance Request for Level 17 on device 103, or upon expiration of the allocated time-period for device 103 to do so, the game-play of the game in device 103 is returned (via automatic re-configuration of the game program code) to Level 8, which was the level that the user of device 103 has reached prior to the Assistance session. In some embodiments, optionally, the successful completion of the Assistance Request on device 103, may optionally provide one or more in-game benefits or rewards to the user of device 103, instead of or in addition to any other compensation or reward that was already offered by the requesting user and/or by the game server 110; such as, such successful assistance may cause device 103 to automatically advance from being at Level 8 to being at Level 9, or may provide to its user in-game benefits such as points or coins or power-up units, or the like.

In another example, the assistance request is received at device 103, while its user is engaging with the same game at Level 24. Even though the user of device 103 had already passed Level 17 by himself and for himself two weeks ago, the game program code that runs on device 103 is configured or modified in view of the incoming Assistance Request to temporarily authorize a time-limited access of the user of device 103 to Level 17, such as for ten minutes only, for the specific purpose of acting as an Assisting User relative to the incoming Assistance Request. Upon successful completion of the Assistance Request for Level 17 on device 103, or upon expiration of the allocated time-period for device 103 to do so, the game-play of the game in device 103 is returned (via automatic re-configuration of the game program code) to Level 24, which was the level that the user of device 103 has reached prior to the Assistance session. In some embodiments, optionally, the successful completion of the Assistance Request on device 103, may optionally provide one or more in-game benefits or rewards to the user of device 103, instead of or in addition to any other compensation or reward that was already offered by the requesting user and/or by the game server 110; such as, such successful assistance may cause device 103 to automatically advance from being at Level 24 to being at Level 25, or may provide to its user in-game benefits such as points or coins or power-up units, or the like.

In another example, the assistance request is received at device 103, while its user is engaging with the same game at the same Level 17. The game program code that runs on device 103 is already configured to authorize the user of device 103 to interact with Level 17. However, in view of the incoming assistance request to pass Level 17 on behalf of another user (the user of device 101), the game program code operates such that device 103 asks its user whether he wishes to continue playing with Level 17 for the purpose of his own progress, or for the purpose of acting as an assisting user that fulfills the assistance request. If the user of device 103 selects to act as assisting user, then, upon his completion of Level 17 “on behalf of” the requesting user (of device 101), then a Request Fulfilled message is transmitted by device 103; and then, device 103 returns again to provide to its user the game-play at the same Level 17, this time for his own engagement and as a condition for is own advancing to Level 18. Alternatively, upon reception of the Assistance Request, the user of device 103 may reject it, and/or may indicate that he would like to play with Level 17 “for himself” and not as an assisting user. In some embodiments, since the user of device 103 is anyway entitled to play right now with Level 17, he may delay his selection until his successful completion of Level 17, and may then indicate to device 103 and/or to game server 110 whether he selects that the successful completion of Level 17 on device 103 would “count” for the game-play on device 103 or would “count” for the game-play on the requesting device 101.

The game program code that runs on the Assisting Device (such as device 102, or 103, or 104), and/or the game management program code that run on game server 110, may track and store two or more records that correspond to two or more progress status records that may co-exist concurrently. For example, the user of device 102 may engage in is regular capacity with the game and may be at Level 8, and accordingly may have an Original-User Record that indicates that the original user of device 102 is currently at Level 8 and has obtained the Rapid Shooter power-up and has not yet obtained the Force Shield power up. Upon an incoming Assistance Request, or upon commencement of the engagement of that user on device 103 in is capacity as an Assisting User (for the purpose of assisting the user of device 101 to pass Level 17), the Original-User Record is “frozen” or locked or otherwise maintained un-changed; and a secondary record, an Assisting-User Record, is generated and updated and utilized by device 103 (and/or by game server 110) to track the current progress of the user of device 103 as he interacts with Level 17 in his role as an Assisting User; indicating that currently he is at “Level 17, third monster”, and that he has already obtained the Double Shooter power-up (e.g., by inheritance of this prior achievement from device 101 which user had already reached that achievement), and that he has not yet obtained the Rapid Shooter power-up (e.g., since the requesting user of device 101 had not yet obtained it on device 101; and even tough the user of device 103 had already obtained this power-up when he had played in his own capacity as an original user). The Assisting-User Record is maintained, updated and utilized for the limited purpose of enabling the user of device 103 to act as assisting user, and for a limited time-period of such assistance role; and then it may be discarded or stored away, and the Original-User Record may be retrieved and re-utilized by the game program code on device 103 and/or by the game management program code on game server 110 in order to enable device 103 to return to its progress status as it was immediately prior to assuming its temporary role as an assisting user.

In some embodiments, optionally, multiple such records may be maintained, utilized and/or updated in parallel for a single electronic device or for a single user; for example, including a single Original-User Record that indicates that the user of device 103 is currently in Level 8 for his own progress, and including a first Assisting-User Record that indicates that the user of device 103 is currently acting in is role as an assisting user in which he is attempting to pass Level 17 on behalf of device 101 which is a requesting device, and optionally also including a second Assisting-User Record that indicates that the user of device 103 was acting yesterday as an assisting user in which he attempted to pass Level 14 on behalf of another device 104 that was a requesting device; and similarly storing records that reflect the current actual progress of the original user of device 103, as well as his “alter ego” progress in is role(s) as an assisting user to other devices, and also reflecting his past or historical performance as an assisting user to one or more other devices in the past.

In some embodiments, optionally, a since electronic device 104 may operate as an assisting device for two (or more) other requesting devices. For example, the user of device 101 is requesting on Monday at 10:00 AM for help in passing Level 17, and offers a payment of USD 1.50 for successful completion within 15 minutes. Similarly, the user of device 102 is requesting, separately, on Monday at 10:01 AM, for help in passing Level 17, and offers a payment of USD 1.40 for successful completion within 20 minutes. The user of device 103 accepts both of these Assistance Requests, one after the other; and engages with Level 17 on his own device 103 in his role as Assisting User, and completes Level 17 on device 103 at 10:09 AM, thereby receiving the two rewards (a total of USD 2.90) from the two users of devices 101 and 102, cumulatively; and a single passing session of Level 17, performed on device 103, may be counted twice towards both device 101 and device 102, causing each one of them to advance its game-play to Level 18, as the user of device 103 had accepted and completed the combined requests for both of them together in one single pass. In some embodiments, optionally, game server 110 may be configured to merge or combine such similar or identical or overlapping request, into a single combined reward; thereby providing an increased incentive for users to act as assisting users, and/or thereby shortening the time that is needed in order to fulfill assistance requests (since two or more assistance requests can now be completed by a single assisting user within a single successful completion of Level 17).

In some embodiments, optionally, the assisting device 103 and/or the game server 110, may record or capture the game-play of the assisting user on device 103, in order to provide proof or evidence of the successful completion, or in order to reduce or prevent fraud (e.g., fraud caused by device 103 being tampered with and then sending out a Request Fulfillment message without actually completing Level 17 on device 103), and/or in order to enable the requesting user and/or other users to watch or view the game-play in which the assistance was indeed provided (e.g., in regular speed, or at increased speed; in real time, or in near-real-time, or later or retroactively after such level completion). In some embodiments, the capturing of the game-play video may be implemented via screen recording or screen grabbing techniques, such as, capturing or recording 15 or 30 frames per second on the assisting device as it performs the fulfillment session of the assistance request. In other embodiments, the capturing of the game-play video may be implemented by capturing the movements or control-gestures or input-commands that the assisting user provide, together with capturing the movement or properties of other in-game items (e.g., enemies shooting, platforms moving, or the like), thereby enabling a subsequent play-back of the assistance game-play via an engine that re-constructs the game-play based on the descriptors of such properties.

In some embodiments, device 104 does not have that particular game installed on it at all; yet, the user of device 104 may indicate to game server 110 that he is willing to act as an assisting user for this game for Levels 5 and above. For example, the user of device 104 had already played that game on his device 104, and had reached level 30 by himself, and had un-installed or removed that game from is device 104; while still being interested in acting as an assisting user for this already-uninstalled game. Subsequently, the game server 110 may still direct Assistance Request(s) to device 104. If the user of device 104 accepts an incoming Assistance Request, then, device 104 may automatically download and/or install and run the suitable program code that enables full operation of that game on device 104, or alternatively, at least a portion of a program code that enables device 104 to run at least Level 17; thereby enabling the user of device 104 to act as an assisting user for a game that was not installed on device 104 at the time-point in which the assistance request was generated. This may enable the user of device 104 to register, at Players Registry 134, as a candidate to be an assisting user to multiple different games, without necessarily being required to have all these games being continuously installed and kept on his device 104, and while enabling device 104 to install on-the-fly or just-in-time (JIT) a particular game for which a current Assistance Request is incoming and is accepted by the user of device 104. This functionality may be implemented via an On-The-Fly Installer Unit 138 which may run on device 104, may fetch or download the game code portion that is needed in order to enable temporary game-play of Level 17 of this game on this device 104.

In some embodiments, a Game Progress Modifier Unit 139 may be part of device 101 (the requesting device) and/or may be part of device 102 (the assisting device) and/or may be part of game server 110; and is shown, for demonstrative purposes, only as part of device 101 in order to not over-crowd the drawing. The Game Progress Modifier Unit 139 may be responsible for some or all of the operations described above; for example, tracking that the requesting user has reached Level 17 on device 101; tracking that the assisting user on device 102 had already reached Level 25 by himself on is own behalf, and is currently operating device 102 as an assisting user in order to pass Level 17 on behalf of device 101; re-configuring or updating the game program code (e.g., on device 101) to reflect that the assisting device 102 has indeed succeeded in fulfilling the assistance request and therefore updating the requesting device 101 to authorize its user to continue the game-play on device 101 at Level 18 and onward; re-configuring or updating the game program code (e.g., on device 102) to reflect that the assisting device 102 has indeed succeeded in fulfilling the assistance request and therefore updating the assisting device to go back to its original level (Level 25); pausing a current game-play on the requesting device 101 in order to initiate a sending of an assistance request; pausing a current game-play on the assisting device 102 in order to handle an incoming assistance request, and freezing (and storing) the game-play status of the original user of device 102 (currently being at Level 25), and temporarily re-configuring or updating the game program code that runs on device 102 to enable device 102 to engage its user with Level 17 as an assisting user; restoring a previously-frozen progress status of the game-play on device 102 upon ending (with success, or with failure) of the time-limited game session in which device 102 was utilized as an assisting device; changing the game-play on device 101 and/or on device 102 to reflect one or more rewards or prizes, such as due to completion of Level 17 by the assisting user on the assisting device; and/or other suitable changes or modifications.

The terms “level” or “particular level”, as used above or herein, my include a particular game-level or game-portion or game-area, or stage in a game; and/or may include a particular milestone or obstacle or challenge within a game (e.g., “the third monster on the top platform”, or “the second Boss creature” or “the moving bridge over the east river”). Accordingly, discussions herein or above which relate to passing of a “level”, may similarly apply, in some embodiments, to passing of a particular obstacle or milestone within a game. For example, a requesting user may request assistance in traversing the moving bridge on the top platform in the game, or may request assistance in defeating the third monster in the in-game forest of the game, or the like; and such tailored assistance may similarly be requested from other users and provided by them.

It is clarified that embodiments of the present invention do not revolve around merely “sharing” the current status or progress or achievement of a first user in a game, with other user(s); such “sharing” activity is merely a notification to other users that a particular user has reached a particular level or milestone, and enabling such other users to merely “read” such notification or to “view” it, optionally also viewing a screen-shot or even a video clip of the achievement, but Not enabling such other recipients to Assist the first user by playing from that point onward on his behalf and on the recipient's own electronic device. Rather, the unique system of the present invention enables one or more assisting users, to assist a requesting user in passing a particular level or obstacle, on their own device(s) (of such assisting users or user) and on his behalf; such that, upon fulfillment of such assistance request, the requesting user immediately enjoys the benefit of such remote passing of the obstacle or level, and is able and authorized to continue playing that game on his own original device from the next level that is subsequent to the particular level (or obstacle) in which he was “stuck” and that for which an assisting user has successfully provided the passing help on the other device.

It is clarified that embodiments of the present invention do not require or involve an assisting user utilizing a remote device 102 in order to “remotely take over” the control of the requesting device 101. Such “remote access” mechanism is cumbersome, and suffers from great delays and latency, as well as security risks (e.g., requiring the first user to allow a remote player to gain remote access to his own device), as well as jittery communications and/or unreliable communications, such that a remote access player cannot efficiently and reliably pass a level or an obstacle on a requesting device via remote access. Even if such “remote access” would be feasible, this is not the unique process in which the present invention operates. Rather, the present invention does not require, and does not involve, a “remote access” of device 101 by the assisting user which operates device 102, which suffers from the above performance problems, security risks, and also causes the “controlled” device 101 to become unavailable for performing other operations. Instead, the present invention enables the requesting user of device 101, to request assistance in passing a particular level of obstacle in a game, without being required to allow such users (who may be complete strangers and are untrusted entities) to “take over” his device 101 via a “remote access” process which may be abused, and without being exposed to the accompanying security risks, and without the assisting user suffering from latency and delays and non-pleasant user experience, and without the requesting device 101 being tied-up to become a “slave device” that is controlled—sometimes for many hours—while a remote user attempts again and again to pass that level remotely on it; and while the requesting user is free and is enabled to utilize is requesting device 101 to perform other activities (e.g., to watch a movie; to compose email messages; to browse the Internet) while other, remote, strangers (including untrusted strangers) are free to utilize their own devices for the purpose of remotely fulfilling the assistance request.

Similarly, the unique system of the present invention does not revolve around merely providing “tips” or “advice” by an assisting user to a requesting user. Instead of communicating with the requesting user via text messages or audio messages, and providing him “advice’ or “tips” that he should attempt to perform by himself (e.g., an advice to jump as his character reaches the edge of the platform, or an advice to shoot the blue monster prior to shooting the red monster), the system of the present invention providers a completely different type of assistance, that does not include and does not require such “tips” or “advice”, but rather, enables an assisting user to actually perform the required operations, on his own device, as if he was the requesting user; and then automatically transferring the “credit” for such success to the requesting user.

Additionally, embodiments of the present invention do not require that the requesting user of device 101, would give the actual physical device 101 to his co-located friend or another co-located person in order to ask him to pass Level 17 (or other obstacle) of the game on behalf of the requesting user and on the physical device 101 itself. Such conventional method suffers from multiple limitations: it requires giving physical access to device 101 to another person, with all the security risks involved in this; it does not enable the requesting user to utilize his own device 101 while another person is utilizing it and trying to pass the level for him; it limits significantly the number of possible helpers that may be involved as they must be physically co-located with the device 101 in order to hold it physically in their hands and/or to interact with it locally via an input unit; the helper may damage the device 101, physically (e.g., dropping it, breaking it) and/or otherwise (e.g., erasing programs from it, hacking it); or the like. Rather, the system of the present invention enables a remote user of a remote device 102, to assist on his own device 102, another user to pass a level or obstacle in a game, without gaining physical and/or virtual and/or remote access to device 101 and/or to the user account(s) of the user of device 101, and without knowing or utilizing a user name and/or a password or other credentials or authentication credentials of the user of device 101 and/or of device 101; and without requiring the user of device 101 to give physical access to his device 101 to another person; and without requiring the user of device 101 to share with another person, or to disclose to another person, his log-in credentials (e.g., to the gaming system, or to the game, or to his email account, or to his social media or social network account, or the like) for the limited purpose of obtaining actual help in passing the level or obstacle in the game.

In some embodiments, the unique system of the present invention may further enable an assisting user to utilize—for the purpose of fulfilling the assistance request—a different type of controller or input-unit, relative to those that are or that were utilized by the requesting user. For example, the requesting user operates device 101 which is a laptop computer having a touch-pad and lacking a computer mouse, and he gets stuck in Level 17 and cannot pass it for several days. The assisting user who accepted the assistance request, is utilizing her own device 102 which is a desktop computer equipped with a computer mouse, which enables her better control of the in-game avatar or character and thus enables her to pass Level 17 efficiently and/or rapidly, on behalf of the requesting user, and by using a different input-unit from him.

Furthermore, the unique system of the present invention is not merely a “sharing of in-game resources” or a “trading of in-game resources” among users of an online game. For example, a conventional online game may enable two users to have two different accounts; the first user having a first account, in which he accumulated so far 50 coins and 30 flowers (or other in-game commodities or resources); and the second user having a second account, in which he accumulated so far 150 coins and 130 flowers (or other in-game resources or commodities); the first user sends a request to the second user, in which the first user asks the second user to “donate” or to “gift” to the first user (or, to “trade” with the first user) 10 coins (or 10 flowers); and the second user may accept the request, which in turn would cause the ten coins (or flowers) to be deducted from the inventory of in-game resources that are “owned” in the game by the second user, and to be “transferred” to the in-game inventory ownership of the first user. Such basic and simple “trading” of in-game resources among users of an online game, which deducts or subtracts or removes in-game resources from one player and transfers them to another player, is not what the present invention revolves around. Rather, the system of the present invention enables an assisting user, to be logged-in via his own regular username, and instead of making progress in a particular game on is own behalf and/or for is own credit, to make such progress (on his own device) such that it would be credited for (or counted for) another user who operates another device under another username, as if it was the other user (the assisted user) that played successfully that level or that traversed successfully that obstacle. This does not require the assisting user to give-up or to subtract or deduct or to give or to donate or to trade any in-game inventor or any in-game achievements of his or any in-game items that he worked hard to achieve.

Furthermore, the system of the present invention may be utilized in games that are entirely single-player; such that a single-player game may request, and obtain, from another user who operates another device, temporary assistance in passing a particular level or obstacle “on his behalf”, and in which “donation” or “trading” or “gifting” of in-game resources has no meaning or application at all. For example, a user who plays a “Pac-Man” or a “Donkey Kong” type of game, on is own tablet, and is stuck at Level 3, may utilize the system of the present invention to request that another player, that utilizes another electronic device, would pass that level on that game on his own (the other player's) electronic device, such that the success of that other player in fulfilling the assistance request would be credited for (or counted for) the requesting player and is own device. In such situations, the conventional concept of “trading” or “gifting” or “donating” or “exchanging” in-game resources among multiple players, by subtracting them from the inventory of one player and adding them to the inventory of another player, is entirely non-applicable and irrelevant, and only the system of the present invention may provide the desired solution.

Additionally, the system of the present invention enables the second user (the assisting user), to be temporarily associated with at least two progress records: a first game-play progress record that corresponds to his own game-play status or progress, and a second, different, game-play progress record that corresponds to his game-play status or progress in his role as an assisting user that only temporarily engages with the game at the particular level or obstacle for which the assistance was requested by the requesting user.

The present invention may further create a new type of computerized activity in the booming field of video games and electronic games; in which users and players of a game, including those of a single-player game, are able to Bid towards each other, directly or indirectly, to request assistance in passing an obstacle for a fee, and/or to provide assistance in passing an obstacle for a fee, and/or to initiate auction or reverse-auction or bidding process among a group of participants, and/or to split or divide the collected funds among a game administrator and/or among participating users; in a manner that injects new opportunities for monetization for game administrators and game operators, and/or in a manner that introduces new opportunities for “garners” and players to earn money and/or to earn rewards (as well as fame and reputation) by completing levels on behalf of other, requesting, user(s).

It is noted that a request for assistance, by a user who is “stuck” on a particular level, that is accompanied by a proposed reward (e.g., USD 2.00) for passing that level on his behalf, need not be regarded as “cheating” or “hacking” the game; rather, the requesting user had already spent many ours of game-play efforts in order to pass Levels 1 through 16 on his own; he had already spent numerous hours in Level 17 but cannot pass it and feels frustrated from his failure, and he also feels frustration from his inability to play Levels 18 through 50 of that game (for which he had paid a considerable price when he purchased the game); and he is thus willing to pay a small reward to relieve the frustration and to gain access to the more advanced levels in the game for which he had paid. This need not be regarded as “cheating” in a game, but rather, as part of a “fair” gameplay that should be regarded as acceptable. Furthermore, in some embodiments, the system may be configured by its administrator, to limit the number and/or timing and/or frequency of such assistance requests that a particular player may place; for example, limiting them to a total of Three such requests in Levels 1 through 40, and/or limiting them to a total of Two assistance requests per calendar month per requesting player, and/or limiting them to a particular level or obstacle that were reported by many players as “un-passable” or as excessively difficult, or the like; thereby enabling the game administrator to be sensitive to the actual needs of the gamers and users that engage with the gaming system and to accommodate their problems and frustration while still maintaining fairness.

Some embodiments may utilize cryptographic operations, encoding, decoding, encrypting, decrypting, hashing, digital signatures, digital certificates, authentication operations, public key/private key cryptography, key-pair cryptography, and/or other operations, in order to ensure that the communications between or among device 101 and/or devices 102-104 and/or game server 110 are secure and/or authentic, and are not prone to injection of messages or false messages by an attacker or an impostor. For example, cryptographic operations may be part of the program code of the game itself as running on devices 101-104, and/or of the program management code as running on game server 110. When an assisting user passes Level 17 on device 102, in her role as an assisting user to an assistance request of device 101, a unique secret code may be generated in device 102 via a cryptographic algorithm and may be transmitted to game server 110, where it is utilized for authenticating that Level 17 was indeed passed; rather than relying on a simple plain-text message of “device 102 has passed level 17”. Similarly, the assistance request, the assistance response, the assistance request allocation message(s), the assistance request acceptance or rejection messages, and the assistance fulfillment messages, messages that command device 101 to unlock a level or to advance to a next level, or other messages that are exchanged in system 100, may be encrypted and/or cryptographically signed, in a manner that allows them to be resistant to tampering or modification and in a manner that authenticates the identity of the sending entity, and/or in a manner that only an authorized recipient entity would be able to open, read or process.

In accordance with embodiments of the present invention, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion herein relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C #, Java, JavaScript, SQL, Ruby on Rails, Go, Cobol, Fortran, ActionScript, AJAX, XML, JSON, Lisp, Eiffel, Verilog, Hardware Description Language (HDL, BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

What is claimed is:

1. A method comprising:
receiving from a first electronic device, a first signal indicating that a first user of said first electronic device requests assistance to pass a particular level in a game;
transmitting to a second electronic device, a second signal indicating an assistance request addressed to a second user of said second electronic device, requesting to pass said particular level in said game as temporary assistance to said first user;
enabling said second electronic device to interact directly with said particular level in said game, on said second electronic device;
if said second user successfully passed said particular level in said game on said second electronic device, then: receiving a third signal from said second electronic device, indicating that said second user successfully passed said particular level in said game via said second electronic device, and in response to said third signal, enabling said first electronic device to interact with said game at a new level that is higher than said particular level.

2. The method of claim 1,
wherein receiving the first signal further comprises: receiving from said first user an indication of a particular second user that said first user selects for fulfillment of said assistance request;
wherein transmitting the second signal comprises: transmitting said second signal to said particular second user that said first user selected.

3. The method of claim 1,
wherein enabling said second electronic device to interact directly with said particular level in said game comprises:
enabling said second electronic device to interact directly with said particular level in said game for only a pre-defined number of attempts.

4. The method of claim 1,
wherein enabling said second electronic device to interact directly with said particular level in said game comprises:
enabling said second electronic device to interact directly with said particular level in said game for only a pre-defined time-period.

5. The method of claim 1,
wherein enabling said second electronic device to interact directly with said particular level in said game comprises:
causing said second electronic device to temporarily run, without permanent installation, only a program code portion that corresponds to said particular level of said game and not to other levels of said game.

6. The method of claim 1,
wherein enabling said second electronic device to interact directly with said particular level in said game comprises:
causing said second electronic device to install and run, only a program code portion that corresponds to said particular level of said game and not to other levels of said game.

7. The method of claim 1,
wherein receiving the first signal further comprises:
receiving from said first user an indication of a group of contacts that are candidates to act as said second user;
publishing to said group of contacts a request to act as said second user;
selecting from said group of contacts the first candidate that responded positively to said request, to act as said second user;
wherein said enabling comprises: enabling to the electronic device of said first candidate, to interact directly with said particular level in said game.

8. The method of claim 1,
wherein receiving the first signal further comprises:
receiving from said first user a message indicating a price that said first user offers for another user to pass said level on behalf of said first user;
publishing to a group of users of electronic devices, a proposal to pass said level on behalf of said first user, together with an indication of the price offered by said first user for such passing of said level within a pre-defined time-period;
selecting from said group of users the first candidate that responded positively to said request, to act as said second user;
wherein said enabling comprises: enabling to the electronic device of said first candidate, to interact directly with said particular level in said game, for said pre-defined time-period.

9. The method of claim 1,
wherein receiving the first signal further comprises:
receiving from said first user a message indicating a maximum price that said first user offers for another user to pass said level on behalf of said first user;
performing a time-limited electronic reverse auction among a group of users of electronic devices, wherein each user proposes a price for passing said level on behalf of said first user, and automatically selecting a lowest bidder in said reverse auction to pass said level on behalf of said first user;
enabling to an electronic device of said lowest bidder, to interact directly with said particular level in said game.

10. The method of claim 1, further comprising:
upon completion of said particular level of said game by said second user on said second electronic device, blocking said second user from accessing levels that are more advanced relative to said particular level, until said second user (i) passes all levels of said game that are less advanced than said particular level and (ii) passes said particular level on his own behalf on said second electronic device.

11. The method of claim 1, further comprising:
determining that said second electronic device currently lacks an already-installed version of said game;
causing said second electronic device to install a reduced-size version of said game, which comprises said particular level of said game and which excludes other levels of said game.

12. The method of claim 1, further comprising:
determining that said second electronic device currently lacks an already-installed version of said game;
causing said second electronic device to run, within a browser and in an installation-free process, a reduced-size version of said game, which comprises said level of said game and which excludes other levels of said game.

13. The method of claim 1, further comprising:
determining that said second electronic device already comprises an installed version of said game;
determining that said second user of said second electronic device, had already passed said particular level prior to a time in which said first signal was generated;
causing said second electronic device to enable a repeated interaction of said second user, on said second electronic device, with said particular level of said game, even though said second user had already passed said particular level on said second electronic device, to enable said second user to pass said particular level again on said second electronic device on behalf of said first user.

14. The method of claim 1, further comprising:
determining that said second electronic device already comprises an installed version of said game;
determining that said second user of said second electronic device, had not yet reached said particular level prior to generation of said first signal;
temporarily advancing a game-play of said game in said second electronic device to enable interaction of said second user with said particular level of said game, even though said second user has not yet reached said particular level, to enable said second user to pass said particular level on behalf of said first user.

15. The method of claim 1, further comprising:
during said enabling of said second electronic device to interact directly with said particular level in said game, capturing a video of said second electronic device interacting directly with said particular level in said game;
subsequently, upon completion of said interacting, making said video accessible for watching on said first electronic device.

16. The method of claim 1, further comprising:
during said enabling of said second electronic device to interact directly with said particular level in said game, generating a live-stream of said second electronic device interacting directly with said particular level in said game, and making said live-stream accessible for watching on said first electronic device.

17. The method of claim 1, further comprising:
collecting from said first user a monetary fee for requesting another user to pass said particular level on his behalf.

18. The method of claim 1, further comprising:
collecting from said first user a monetary fee for requesting another user to pass said particular level on his behalf, wherein said collecting is completed only if another user has actually passed said particular level on behalf of said first user within a pre-defined time-period.

19. The method of claim 1, further comprising:
collecting from said first user a monetary fee for requesting another user to pass said particular level on his behalf;
providing a portion of said monetary fee, to a particular assisting user that passed said particular level in said game on behalf of said first user within a pre-defined time-period.

20. The method of claim 1,
wherein said first electronic device comprises a device selected from the group consisting of: a smartphone, a tablet, a portable gaming device, a non-portable gaming device, a laptop computer, a desktop computer;
wherein said second electronic device comprises a device selected from the group consisting of: a smartphone, a tablet, a portable gaming device, a non-portable gaming device, a laptop computer, a desktop computer.
